(19) United States
(12) Patent Application Publication
(10) Pub. No.: US 2015/0317441 A1
(43) Pub. Date: Nov. 5, 2015

(54) INTELLIGENT NUCLEAR MEDICINE PATIENT WORKFLOW SCHEDULER

(71) Applicant: KONINKLIJKE PHILIPS N.V., Eindhoven (NL)

(72) Inventors: Benjamin LORMAN, Solon, OH (US); Yu-Lung HSIEH, Highland Heights, OH (US); Varun VERMA, Cleveland, OH (US); Chi-Hua TUNG, Aurora, OH (US); Changhong DAI, Willoughby Hills, OH (US)

(21) Appl. No.: 14/647,493

(22) PCT Filed: Dec. 2, 2013
(86) PCT No.: PCT/IB2013/060547

§ 371 Date: May 27, 2015

Related U.S. Application Data
(60) Provisional application No. 61/732,457, filed on Dec. 3, 2012.

(51) Int. Cl. G06F 19/00

(52) U.S. Cl. CPC G06F 19/327; G06F 19/3443

(57) ABSTRACT

A nuclear medicine scanner system (1) includes an intelligent scheduler (2) which schedules a plurality of patients, each for an ordered nuclear medicine scanning procedure with a nuclear medicine scanning device (4) based on data mined from prior patients with like scanning procedures and in a time window which minimizes the patient dose.

The following relates generally to nuclear medical imaging and patient workflow. It finds particular application in conjunction with the scheduling of patients undergoing diagnostic imaging procedures using a radiopharmaceutical, and will be described with particular reference thereto. However, it will be understood that it also finds application in other usage scenarios and is not necessarily limited to the aforementioned application.

Nuclear medicine typically involves the use of a radiopharmaceutical which targets a metabolic activity for diagnosis of a disease. The radiopharmaceutical is usually injected and after a time of uptake by the metabolic activity, the patient is imaged in an imaging scanner such as a Positron Emission Tomography (PET) scanner, Single Photon Emission Computed Tomography (SPECT), and the like. Images are generated by measuring the photon emissions due to the radiopharmaceutical decay.

The patient to undergo a nuclear medicine imaging procedure is typically scheduled for a date and time by the requesting physician, and the scheduled date and time is based on the availability of a scanner which scans only one patient at a time. A radiopharmacy typically delivers unit doses of radiopharmaceuticals 1-2 times per day of operation for the patient scheduled for that day or portion of a day. The radiopharmaceuticals have a short half-life. For example, radiopharmaceuticals which include Fluorine 18 have a half-life of approximately 109 minutes, and radiopharmaceuticals which include Gallium 68 have a half-life of approximately 68 minutes. Radiopharmaceuticals have a strength based on the amount of radiation emitted. Guidelines are provided for scan times and for dosages based on body size and the strength of the dosage which typically ranges 5-35 milliCuries (mCi) for a 70 kg adult. However, due to the half-life and the duration between the delivery from the pharmacy and the administration to the patient, the strength can decrease significantly. For example, if a 20 mCi Gallium 68 radiopharmaceutical vial is delivered at 8:00 am, then at 9:08 am the effective unit dose has dropped to 10 mCi, and at 10:16 am the effective dose has dropped to only 5 mCi.

The patient arrival is based on the time in which the patient is scheduled to receive the injection of the radiopharmaceutical. The patient receives the injection and waits in a quiet space for a period during which the uptake occurs prior to imaging, typically thirty minutes to one hour. The patient is loaded onto an imaging table of the scanner device. For most patients the loading occurs within minutes, but some patients may have special needs or require additional time to be placed on the scanner table. After the patient is loaded, the patient is scanned. The scan time is based on the scan type, the scanner, and the strength of the radiopharmaceutical at the time of imaging. The scan time can be extended as the strength of the radiopharmaceutical decreases to a minimum level. After the scan is completed an image is reconstructed and reviewed for image quality, then the patient is unloaded from the table. Again, for most patients this may occur relatively quickly, but for some patients, the time can be extended such as for non-ambulatory patients or unconscious patients. Once the table has been unloaded, the next scheduled patient can be loaded onto the table.

The scanning device is a constraint in scheduling and can only accommodate a single patient. The time of use by a single patient includes the time of loading and unloading, and the scan time which is dependent upon the strength of the radiopharmaceutical at the time of imaging. Sites can scan as many as 24 patients in one day depending on the hours of staffing. Some sites, in response to the management complexities of scheduling patients and ordering radiopharmaceuticals, order or purchase a number of unit doses based on a number of patients scheduled for the day or portion of the day without regard to individual patient characteristics. Purchasing a number of unit dosages simplifies the ordering, receiving, and tracking by avoiding patient dependencies to specific unit doses. The sites will typically administer a whole unit dose to each patient, which may be within the broad guidelines, but may be a higher dosage than necessary for the diagnostic imaging procedure.

The complex management of time dependencies is further acerbated by dynamic changes to the schedule and workflow, which can occur the day of the procedure. Emergency scans can be added, and cancellations and delays occur. Scheduling includes staffing constraints which includes breaks and other time constraints.

Some sites set scheduling and imaging workflows based on expected system throughput. The schedule usually includes block scheduling based on industry averages fixed at the time of the workflow creation. The workflows are typically static and do not accommodate patient specific factors such as loading/unloading, and time limits a patient can spend on the table. The workflows do not factor the declining strength of a radiopharmaceutical due to the half-life and the impact on the scan time. The static workflows do not accommodate changes based on new procedures, new radiopharmaceuticals, best practices, and/or local customizations and work environment changes.

The following discloses a new and improved intelligent nuclear medicine workflow scheduler which addresses the above referenced issues, and others.

In accordance with one aspect, a nuclear medicine scanner system includes an intelligent scheduler which schedules a plurality of patients, each for an ordered nuclear medicine scanning procedure with a nuclear medicine scanning device based on data mined from prior patients with like scanning procedures and in a time window which minimizes the patient dose.

In accordance with another aspect, a method of scheduling nuclear medicine imaging includes scheduling a plurality of patients, each for an ordered nuclear medicine scanning procedure with a nuclear medicine scanning device based on data mined from prior patients with like scanning procedures and in a time window which minimizes the patient dose.

In accordance with another aspect, a nuclear medicine scanner system includes at least one processor configured to schedule a plurality of patients for an ordered nuclear medicine scanning procedure for a nuclear medicine scanning device. Each patient is scheduled for an arrival date and time, a time and an amount of a unit radiopharmaceutical dosage, and a time and duration of a scanning procedure. The time and the amount of the unit radiopharmaceutical dosage are based on the ordered procedure, the patient characteristics and the arrival time. The time and duration of a scanning procedure based on the time and dosage of the radiopharmaceutical, patient loading/unloading requirements, and the ordered procedure. The at least one processor is further configured to forecast based on received unit doses of radiopharmaceuticals, and the arrival of the plurality of scheduled patients. The forecast includes the time to administer to each received unit dosage of radiopharmaceutical to each patient, the time and duration to load each patient into the scanning device, the time and duration to perform the ordered scanning procedure, and the time and duration to unload each patient from the scanning device.

One advantage is dose optimization for individual patients.

Another advantage resides in optimized system throughput based on intelligent scheduling.

Another advantage resides in use of best practices in localized incremental workflow improvements to scheduling nuclear medicine scanning procedures.

Another advantage resides in accommodating site differences and/or customizations.

Still further advantages will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

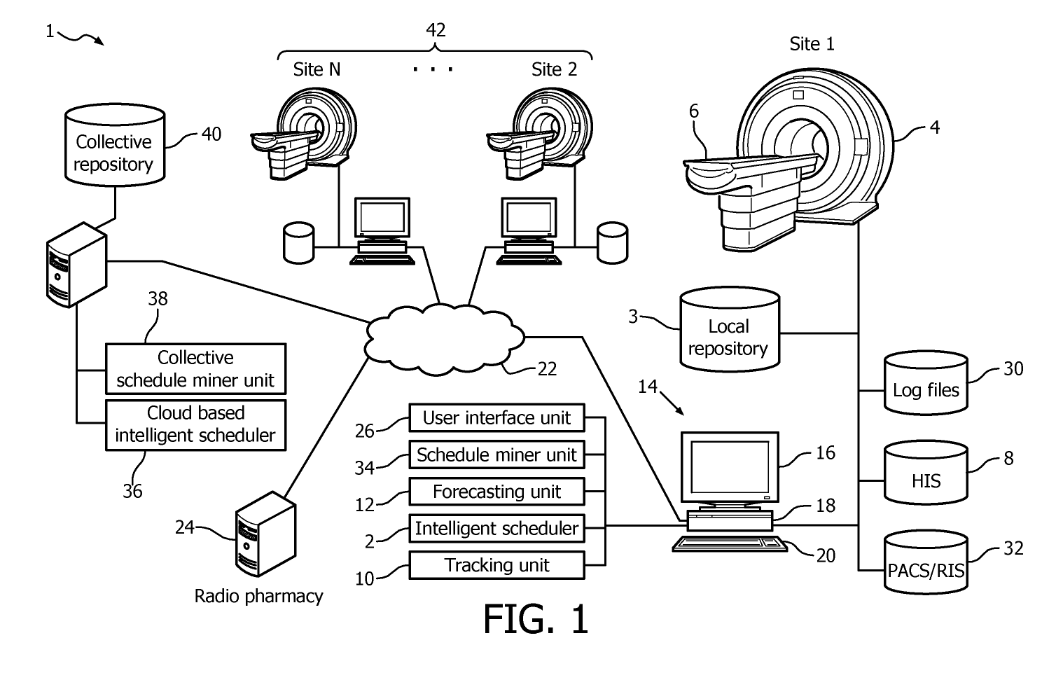

FIG. 1 schematically illustrates an embodiment of an intelligent nuclear medicine workflow scheduler system.

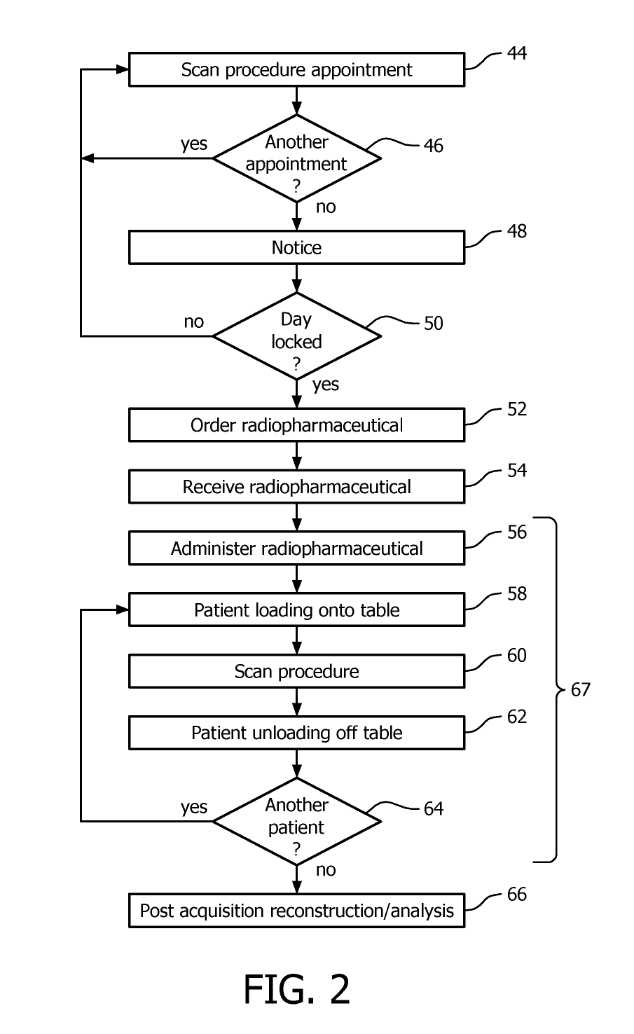

FIG. 2 flowcharts one embodiment of a method of intelligent nuclear medicine workflow scheduling.

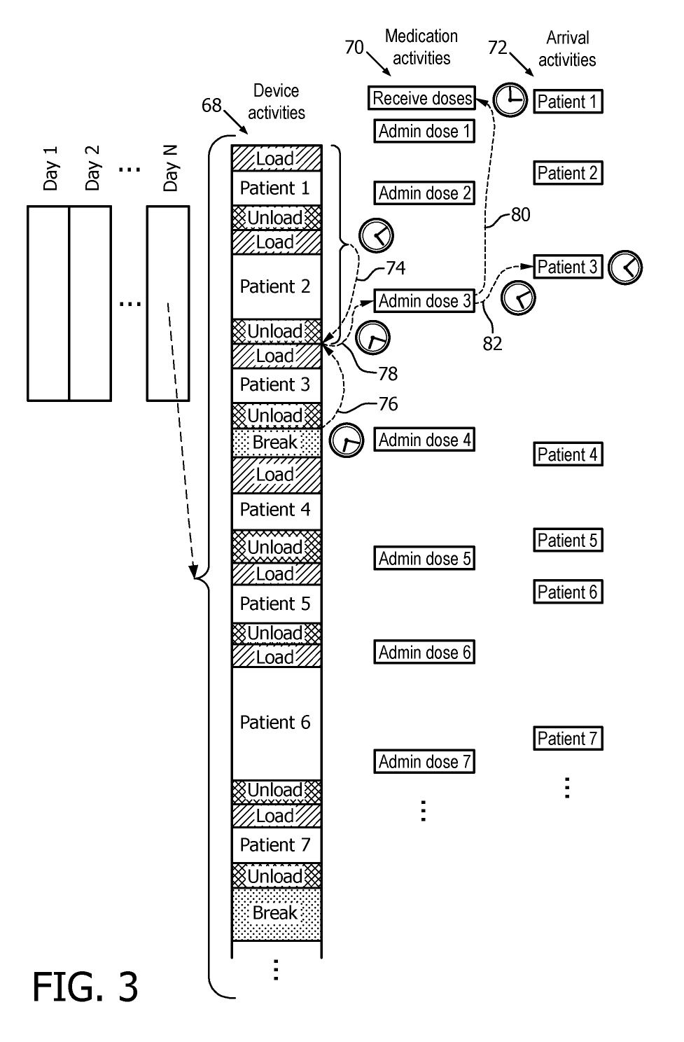

FIG. 3 diagrammatically illustrates an exemplary schedule of the intelligent nuclear medicine workflow scheduler system.

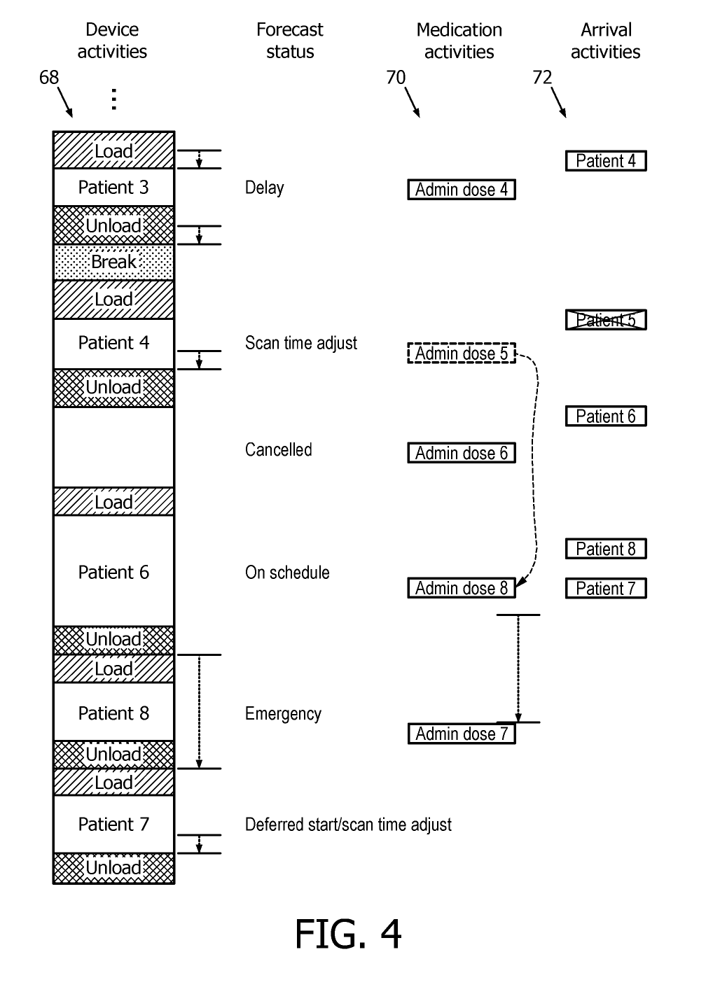

FIG. 4 diagrammatically illustrates an exemplary forecast of the intelligent nuclear medicine workflow scheduler system.

With reference to FIG. 1, an embodiment of an intelligent nuclear medicine workflow scheduler system 1 is schematically illustrated. The system 1 includes an intelligent scheduler 2 which schedules patients for a nuclear medicine scanning procedure typically ordered by an ordering healthcare practitioner. The intelligent scheduler schedules a plurality of patients, each for an ordered nuclear medicine scanning procedure with a nuclear medicine scanning device 4 based on data mined from prior patients with like scanning procedures and in a time window which minimizes the patient dose. The period of optimization can include a day, a portion of a day, a number of days. The intelligent scheduler can be operated by a healthcare practitioner in voice communication with the ordering healthcare practitioner or directly via a network interface such as a website.

A repository of data mined from prior patients 3 includes data from scanned procedures of prior patients in an organized format such as a database. The data can be indexed or summarized. The repository 3 can include a radiopharmaceutical administered to the prior patient, and an administered unit dose of radiopharmaceutical. The repository can include one or more regions of interest targeted by the radiopharmaceutical or imaging protocol. The repository can include prior patient characteristics such as gender, age, weight, disease, etc. The repository can include the scan protocol, measures of image quality, wait times between administering the radiopharmaceutical and the time of scanning. The repository can include a scan duration, a time of day, a type of scanning device and/or characteristics of the scanning device such as device options. For example, the type of device can include PET, whether the PET includes time-of-flight (TOF), and other imaging type information. In another example, device options for a PET device can include the operating conditions such as minimum table height, bore opening, etc. which can affect patient loading, unloading. The repository can include hours of operation for a site operating the scanning device, years of experience, certifications, etc. The repository can include additional information which highlights best practices of nuclear medicine, and flags and/or weights assigned to specific scanned procedures based on protocols, images, radiopharmaceuticals, reported literature, etc. The repository can include prior patient individual occurrences of scanned procedures, or statistical information summarizing the data such as mean, minimum, maximum, standard deviation, etc. For example, the repository can include the average of prior patient scan times for each radiopharmaceutical grouped by gender and patient weight range for prior patients with scanned procedures involving tumors. The grouping can include those diagnosed with tumors and those without tumors. The average scan time can be associated with other mined data such as an average, a minimum, and/or a maximum dose, and the like.

Each patient is scheduled for an arrival date and time, e.g. within a 3 day window. About a month before the exam a specific time and day are set by the intelligent scheduler. The arrival date and time are based on the scanning device 4 availability, the duration of the scanning procedure optimized for patient throughput and for minimized patient dose and based on patient characteristics. The scanning device 4 can include a Positron Emission Tomography (PET) scanner, Single Photon Emission Computed Tomography (SPECT) scanner, and the like. For example, a patient is scheduled for arrival at 8:45 am on a day where the PET scanner is available at 9:30 for a 20 minute scanning procedure. The time between 8:45 am and 9:30 includes a time to inject the patient with a radiopharmaceutical and for the patient to wait in a quiet area for uptake prior to the scanning procedure. A patient characteristic such as a limit of time in which the patient can lie on a scanning table or patient support 6 can be included in the scheduling constraints. For example, a scanning procedure may typically call for a 30 minute scan period, but a patient can only comfortably lie still for 20 minutes. The scheduler can schedule a 20 minute scan period and indicate a higher dose requirement of the radiopharmaceutical.

The intelligent scheduler can further schedule a time and an amount of a unit radiopharmaceutical dosage based on the ordered procedure, patient characteristics, the arrival time, and the scheduled time of the scanning procedure. For example, a patient weighing 70 kg and arriving at 8:45 for a 9:30 scan time is scheduled for injection of a radiopharmaceutical such as 10 mCi of Gallium 68 at 9:00 am. The radiopharmaceutical may be delivered to scanning site at 8:00 am as 20 mCi of Gallium 68. The amount of radiopharmaceutical is optimized for the time of injection and subsequent patient throughput at the scanning device, but includes the patient characteristics such as the mass of the patient, and can include other scheduling constraints such as a maximum time the patient can spend on the patient support 6 of the scanning device 4, and the like. The intelligent scheduler marks as unavailable non-operating hours and staffing breaks. The intelligent scheduler can optimize the schedule by extending the scan time of a patient to fill otherwise unused time and reducing the amount of the administered radiopharmaceutical accordingly. For example, if a patient scan time would leave a 5 minute gap before a break, then the scan time can be extended by 5 minutes and the dose of the radiopharmaceutical reduced correspondingly.

The intelligent scheduler 2 schedules the time and the duration of the ordered scanning procedure based on the time and dosage of the radiopharmaceutical, patient loading/unloading requirements, and the ordered procedure. With a given start time of the scan, the duration of the scanning procedure can be determined from the time and dosage of the radiopharmaceutical. Ideally, the lowest dose that is projected to produce a satisfactory image is selected. But, if available scan times are too limited, the dose can be increased, within patient safety limits, to match the available scan time. The patient loading requirements include the time to load the patient onto the table. For example, an ambulatory patient can be loaded onto the patient table and the scan procedure start within 5 minutes. A 20 minute scan time to begin at 9:30 am will actually start at 9:35 with a 5 minute patient loading and end at 10:00 with a 5 minute unloading. The next available period for scheduling of the scanning device would be 10:00 with injection of the next patient an appropriate time earlier. Each scheduled scanning procedure includes a loading period and an unloading period. The loading and unloading periods are based on the patient requirements, and can include measures of patient mobility. Measures of patient mobility can include patient age, patient weight, a patient height-mass ratio, ability to walk or ambulatory status, and whether the patient is conscious. Patient characteristics and measures of patient mobility can be received from the ordering healthcare practitioner, or can be obtained from a patient records system such as a hospital information system (HIS) 8, and the like.

The intelligent scheduler can generate a radio pharmacy order list of unit doses of the radiopharmaceuticals corresponding to the patients scheduled for a specific day or portion of the day. For example, one list may be generated for a morning delivery, and a second list generated for an afternoon delivery. Each dose included on the list corresponds to a scheduled patient and is based on the scheduled time of injection. The order list can be based on the scheduled times of injection or be based on a scheduled time of delivery and half-life decay until the time of injection.

The system 1 includes a tracking unit 10 which tracks each received order unit dose of radiopharmaceutical with time and the patient corresponding to each dose. The tracking unit records the time and strength at receipt, and with table lookups of a radiopharmaceutical half-life can determine the strength at any point in time during the day including the scheduling time of injection or in the instance of a delay, a forecasted time of injection or imaging.

The system 1 includes a forecasting unit 12 which forecasts the time to administer unit doses to each remaining scheduled patient for the day, and the time and duration for the scanning procedure. The forecast is based on information from the tracking unit 10 and information about arrivals, delays, cancellations, and emergencies entered by the healthcare practitioner during the daily schedule. The time and duration of the scanning procedure includes the time and duration for loading the patient into the scanning device 4 and for unloading the patient from the scanning device 4. As discussed with reference to the intelligent scheduler 2, the forecasting unit 12 uses the characteristics of the patient, and the loading/unloading requirements to determine the time and duration of the forecasted schedule.

The forecasting unit can alternatively be used to plan a daily schedule using “what if” scenarios prior to the scheduled day and during the scheduled day with the remaining activities. “What if” scenarios include the healthcare practitioner identifying at least one potential change in the schedule such as a cancellation, an emergency addition, a delay in administering a dose, a longer wait after administering the dose and before loading, a delay in loading, a delay in scanning, a delay in unloading, etc., and the forecasting unit forecasts the schedule for the remaining period based on the impact to other patients and the overall schedule. “What if” scenarios do not actually change the schedule, but can commit the proposed changes to the forecast with a command by the healthcare practitioner using the at least one input device. The “what-if” scenario forecasting can provide incremental improvements to scanning throughput by allowing the healthcare practitioner to evaluate the impact of potential changes to the schedule. The healthcare practitioner can identify through a workstation 14 hard constraints such as activities underway, staffing breaks, or fixed scheduled appointments. The forecasting unit determines the impact of any changes or proposed changes to the schedule and displays the result on a display device 16. The workstation 14 includes at least one electronic processor or processing device 18, the display device 16, and at least one input device 20. The workstation 20 can be a desktop computer, a laptop, a tablet, a mobile computing device, a smartphone, and the like. The input device 20 can be a keyboard, a mouse, a microphone, and the like. The workstation can connect to a network 22 and to the scanning device 4 or can be separated. The generated order list of radiopharmaceuticals can be transmitted via the network to a radiopharmacy 24. For example, a portable document format can be generated and sent as an email attachment with a digital signature to the radiopharmacy. A purchase order or other related information can be included in the attachments. Alternatively, the generated order information can be transmitted or uploaded to an internal computing device such as an internal order management server which actually places the order with the radiopharmacy. The receiving of the radiopharmaceuticals can be entered into the tracking unit via the workstation 14, or transmitted from an internal receiving system. The information recorded and received by the tracking unit 10 includes the specific radiopharmaceuticals and doses at time of delivery.

The forecasting unit 12 and the intelligent scheduler 2 use mined data loaded into the local repository 3 to optimize the schedule and forecast. The local repository includes data mined from data sources such as log files 30 of the scanning device 4, the Hospital Information System 8, a Picture Archiving and Communication System (PACS) and/or Radiology Information System (RIS) 32. A schedule miner unit 34 extracts, transforms, and loads the data to the local repository 3. Information can be extracted from log files of the scanning device which provide patient weights, times, doses, duration of events, etc. of previous scans which produced acceptable images. Information can also be extracted from the DICOM header information of images from prior nuclear medicine procedures located in the PACS/RIS 32. The information can be further supplemented with patient specific information located in the HIS 8 or other patient record sources.

The transform provided by the schedule miner unit 34 includes selection and/or grouping of the data and constructing statistics which can be used for scheduling and/or forecasting. Information can be selected or grouped by radiopharmaceutical, administered dose of the radiopharmaceutical, a region of interest, a scan protocol, scan duration, time of day of the scan and/or administered dose, and the like. For example, an average scan time scan can be constructed for patients undergoing a whole body scan for a tumor using a Gallium 68. A separate average can be provided for loading and one for unloading of the same patient population. When scheduling a new patient procedure, the healthcare practitioner can review information provided by the intelligent scheduler and/or forecasting unit from the local repository to determine a best time and duration for the new patient. Alternatively, the system can provide a proposed schedule based on the available information and parameters such as an average duration+n*standard deviation where is a safety factor. The proposed schedule can be reviewed and/or revised by the healthcare practitioner.

The functions of the intelligent scheduler 2, the schedule miner unit 34, and/or the local repository 3 can be extended to cloud based computing with a cloud based intelligent scheduler 36, collective schedule miner unit 38, and/or a collective repository 40. The cloud based intelligent scheduler 36 operates as a web-based service. The cloud based intelligent scheduler includes the functions of the intelligent scheduler 2 using data either entered by the healthcare practitioner and/or based on the data of the collective repository 40 instead of the local repository 3. The collective schedule miner unit 38 can mine data from a plurality of scanning devices and/or sites 42, e.g. for imaging sessions of like patients for like medical problems. The mined data can be further transformed by including selection and/or ordering by type of scanning device, scanning device options, hours of operation, best practices, and the like. For example, an organization just implementing a new scanner can use the cloud based intelligent scheduler 38 to schedule and forecast. As the organization practices, local log files 30, the PACS/RIS 32 can be mined for local practices. The organization may prefer to schedule and forecast at the local site, e.g. site 1. More experienced organizations may prefer to schedule and forecast locally, but also to consult with the collective repository 40 through the cloud based intelligent scheduler for recommendations on new procedures and/or radiopharmaceuticals for recommended scheduling scan times, administration times, loading times, and unloading times. The intelligent scheduler and the cloud based intelligent scheduler offer incremental improvement opportunities to a site.

The intelligent scheduler 2 and various units 10, 12, 26, 34, 36, 38 are suitably embodied by an electronic data processing device, such as the electronic processor or electronic processing device 18 of the workstation 14, or by a network-based server computer operatively connected with the workstation 14 by the network 22, or so forth. The user interface unit 26 is suitably embodied by the workstation 14. Moreover, the disclosed scheduling, forecasting, and data mining techniques are suitably implemented using a non-transitory storage medium storing instructions (e.g., software) readable by an electronic data processing device and executable by the electronic data processing device to perform the scheduling, forecasting and mining techniques.

FIG. 2 flowcharts one embodiment of a method of intelligent nuclear medicine workflow scheduling with data mined for doses, times, protocols, etc. for like patients with like problems. In a step 44, intelligent scheduler 2 schedules a nuclear medicine scan procedure in a 3 day window based on the availability of a scanning device and the constraints of the ordered procedure and the patient characteristics. The constraints of the patient characteristics includes information which determines time to load and unload the patient such as measures of mobility, and the time of the scanning procedure which can include a time limit the patient can lie down for the scanning procedure. The scheduling step is repeated based on a decision step 46 as each patient is scheduled for a day and time. The intelligent scheduler 2 schedules the arrival date and time based on the start time of the scanning procedure including the loading of the patient onto the patient support 6, the time of the amount of a determined unit dose of the radiopharmaceutical for the scanning procedure ordered, and any site specific procedures or customizations, and the duration of the ordered scanning procedure. The unit dose of the radiopharmaceutical is determined based on patient characteristics such as weight and the order procedure. The schedule time of the scanning procedure includes the patient loading and unloading periods. The patient loading and unloading periods are based on the patient characteristics which include measures of mobility. The scheduling includes constraints such as hours of operation and staffing breaks to best fit the duration blocks of each scheduled patient into times between staffing start times, staffing breaks, shift end times, etc. Cancellations can be made and the time period is marked as open. Additions can be made into an open time window if the addition can fit within the vacated time window.

A notice is sent to the patient or patients scheduled in a step 48. The notices can be sent individually as each scanning procedure is scheduled or batched and sent as a group. The notice can be sent electronically such as via email or can be sent on paper through postal services.

A scheduled day can be locked, e.g. about a month before the scheduled scanning procedure in a step 50. Other days can continue to be scheduled. Locking can occur just prior to ordering radio pharmaceuticals for the patients scheduled for the locked day and is based on the lead time for ordering from a radio pharmacy the unit doses of radiopharmaceuticals. The locking can include a time period, e.g. day in which the schedule optimization is complete and notices are sent to the scheduled patients.

The unit doses to be ordered are generated in a step 52 by the intelligent scheduler 2, and include an expected date and time of delivery at a specific location, e.g. the site of the scanning device. The unit doses correspond to the patients scheduled for the day and are based on the ordered scanning procedure and the patient characteristics. For example, a specific dose corresponding to a patient A includes the patient mass, and can include a dose adjustment based on the expected time of delivery, the schedule time of administration of the dose, and the start time and duration of the scanning procedure. The duration of the scanning procedure can be limited by patient characteristics such as limits on how long the patient can lie on the patient support 6 of the scanning device 4. The delivered dose can be lowered for an earlier scheduled patient or lowered based on the patient mass. The delivered dose can be raised for a later scheduled patient or a large patient, e.g. greater mass.

The received unit doses are recorded by the tracking unit 10 in a step 54. The unit doses can be verified and received as a group and/or recorded individually. The healthcare practitioner can enter the information through the user interface unit 26, or the information can be received from a pharmacy receiving system and input devices such as a barcode reader and the like. Missing/unusable unit doses and any delays in receiving can be recorded in the tracking unit.

The radiopharmaceutical is administered in a step 56 and the time of administration is recorded. The intelligent scheduler 2 provides a scheduled time of administration. Delays can be computed based on planned or actual differences from the scheduled time of administration. The administration of the radiopharmaceutical can be delayed based on a delay in the arrival time. The actual patient arrival time can optionally be tracked through the forecasting unit 12. The tracking unit can confirm the dose for the patient at the time of administration based on the patient characteristics and the time and duration of the ordered scanning procedure.

The patient is loaded onto the patient support table in a step 58 during the scheduled period of loading. The time of loading can be recorded through the user interface unit 26 such as a positive confirmation of time, or retrieved from the log files 30. Delays can be forecasted for the remainder of the schedule.

In a step 60, the ordered scanning procedure is performed using the scanning device. Scan times can be adjusted as a function of the actual time and dosage of the radiopharmaceutical. Extended scan times can be utilized which are received by the forecasting unit. Extended scan times based on initial viewing of images by a healthcare practitioner may warrant a delay, but which can impact later schedule patients. Image reconstruction can begin as data is received and with distributed and parallel processing avoid being a constraint in the scheduling. Images can be displayed on the display of the workstation 14 or on a separate display.

In a step 62, the patient is unloaded from the scanning device. The system can request a positive confirmation of the end time at the conclusion such as with the loading or receive an actual time entered or retrieved from the log files.

The process of loading, scanning, and unloading can be repeated in a decision step 64 for each patient. The scanning device throughput can be optimized based on improved measures of planning accuracy of each phase of scanner use which includes the loading, scanning, and unloading. Post acquisition reconstruction and analysis is performed in a step 66. Post acquisition reconstruction distributes and avoids use of the scanning device and uses the recorded data from the scanning procedure.

Forecasting includes revising the schedule from the steps 67 for each subsequent patient which include administering 56 the radiopharmaceutical, loading 58 the patient onto the patient support, scanning 60 the patient according to the ordered nuclear medicine scanning procedure and any extensions, and unloading 62 the patient from the patient support. Forecasting can include “what if” scenario where potential changes are evaluated for the impact to later or downstream scheduled patients. Changes evaluated in “what-if” scenarios such as cancellations or adding an emergency patient can be committed to the schedule.

FIG. 3 diagrammatically illustrates an exemplary schedule of the intelligent nuclear medicine workflow scheduler system 1. The intelligent scheduler 2 schedules scanning procedures for each day. The example schedule is exploded for a single day N. The schedule includes activities related to throughput 68 at the scanning device 4, activities related to the administration of the radiopharmaceutical 70, and patient arrival activities 72. The scheduling of patient 3 is explained in greater detail to illustrated the dependencies in scheduling.

The intelligent scheduler 2 schedules each patient for the next open position on a daily basis. The day can be subdivided into morning and afternoon and treated as separate days for purposes of schedule flexibility. In selecting the next open position, the schedule aggregates previously scheduled time 74 for each prior patient, which includes the loading time, the unloading time, and the scan time. The loading and unloading times are scheduled based on the patient characteristics such as measures of mobility. In the schedule, patient 4 is scheduled with longer load and unloading times due to a mobility measure such as being non-ambulatory. The scan time is based on the ordered procedure and the scheduled dose at the time of the procedure. In the example schedule, the intelligent scheduler aggregates the loading, scan, and unloading times for patients 1 and 2. The scheduled times for loading, scanning, and loading patients 1 and 2 can be based on the scheduled times established at the time of the scheduling of each of patients 1 and 2. The times can be revised based on additional information received afterwards and prior to the scheduling of the next open position for the day. Further modifications to the schedule are included in the forecasting unit 12.

The intelligent schedule 2 in selecting the next open position further includes staffing constraints 76 such as breaks, meals, and hours of operation. In one embodiment, the staffing constraints are hard constraints. In alternative embodiment, the staffing constraints can be weighted and/or given a variable start such as +x minutes. For example, if an open position can be utilized by scheduling a break 5 minutes later, then the break is shifted, the scanning procedure scheduled, and the next open position is scheduled for after the break. Otherwise, the scanning procedure is scheduled after the break in the next open position.

The intelligent scheduler 2 schedules the time and dose of the radiopharmaceutical 78 for the scanning procedure based on an optimized scanning throughput. The dose is based on a dose at scan time revised for administration at a certain time and the patient characteristics such as the patient mass. An ordered dose can include a further revision based on the scheduled time of receipt 80 at the scanning site. The intelligent scheduler further schedules the arrival time 82 with the appropriate lead time for the administration of the radiopharmaceutical. The lead time can include time for site specific orientation and instructions to the patient prior to injection of the radiopharmaceutical.

Cancellations are handled by the intelligent scheduler 2. The position in the schedule is marked as open. Additions to the schedule are scheduled in the next open position which can include the scanning procedure to be scheduled including the loading and unload periods.

FIG. 4 diagrammatically illustrates an exemplary forecast of the intelligent nuclear medicine workflow scheduler system 1. In the example forecast, patient 3 arrives and is non-ambulatory and unexpectedly requires extra time in loading onto the patient support 6 and unloading from the patient support. Furthermore, patient 5 cancels and an emergency patient 8 is added to the schedule.

The delays due to the loading and unloading of patient 3 shifts start time of the break later, which in turn shifts the start time of the loading of patient 4 later. The radiopharmaceutical for patient 4 has already been administered and to accommodate the delay, the forecasting unit 12 forecasts adjusting the scan time for patient 4. The shift would continue for downstream scheduled patients, but patient 5 has cancelled so the effect for the delay is limited to patient 4, and the forecast status for the next patient, patient 6 is forecast as on schedule. The forecasting unit fills vacated patient 5 slot with new patient 8 if patient 8 arrives in time. Otherwise, patient 8 is scheduled as an emergency patient as shown in the example which causes a delay in patient 7. The impact to the schedule can be evaluated using “what-if” patient 8 arrives after patient 6 is administered his/her dose and/or is being scanned. Alternatively for patient 6 with the cancellation of patient 5, the unit dose can be reduced and the scan time increased with an earlier scan time without affecting patient 7.

The arrival of emergency patient 8 is inserted in the schedule prior to patient 7. The forecasting unit can forecast using “what if” scenarios prior to actually adding patient 8 to the schedule to determine the impact to subsequently schedule patients. The radiopharmaceutical may be taken from a cancelled patient such as patient 5, if the type and dose are suitable to the patient characteristics, or a unit dose may need be delivered from the radio pharmacy. Patient 8 is inserted into the schedule prior to patient 7. The forecasting unit 12 can delay patient 7 similar to the delay to patient 4 or can move the delay further upstream with a deferred start in the administration of the radiopharmaceutical to patient 7. In changing the time of the administration of the radiopharmaceutical, the forecasting unit 12 calculates the decay in the radiopharmaceutical and then forecasts a scan time adjustment based on the delayed start time. For forecasted scenarios in which no solution is possible, e.g. radiopharmaceutical is below minimum, an alert is displayed on the display device.

It is to be appreciated that in connection with the particular illustrative embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof. That is to say, it will be appreciated that various of the above-disclosed and other features and functions, or alternatives thereof, may be desirably combined into many other different systems or applications, and also that various presently unforeseen or unanticipated alternatives, modifications, variations or improvements therein may be subsequently made by those skilled in the art which are similarly intended to be encompassed by the following claims.

1. A nuclear medicine scanner system, comprising:
an intelligent scheduler which schedules a plurality of patients, each for an ordered nuclear medicine scanning procedure with a nuclear medicine scanning device based on data mined from prior patients with like scanning procedures and in a time window which minimizes the patient dose.

2. The system according to claim 1, wherein the time window includes
a time and an amount of a unit radiopharmaceutical dosage based on the ordered procedure, at least one patient characteristic and the arrival time; and
a time and a duration of a scanning procedure based on the time and dosage of the radiopharmaceutical, patient loading/unloading requirements, and the ordered procedure.

3. The system according to claim 1, wherein the data mined includes selecting and/or grouping of data from prior patients by at least one of:
radiopharmaceutical;
administered unit dose of radiopharmaceutical;
a region of interest;
patient weight;
disease;
a scan protocol;
wait times from administering a radiopharmaceutical until scanning;
image quality;
scan duration;
time of day;
type of scanning device;
device options;
hours of operation; and
best practice of nuclear medicine.

4. The system according to claim 1, wherein the schedule of the plurality of patients for a day is optimized which includes adjusting the schedule of at least one patient to fit into the available time window by extending the time window and reducing the administered dose.

5. The system according to claim 1, wherein the schedule of the plurality of patients is optimized over a span of a plurality of days based on the time needed for a quality image and a minimum dose for each patient compared with a group of prior patients, and including hours of operation and staffing breaks.

6. The system according to claim 1, wherein the patient characteristics includes at least one of:
a mass of the patient;
a maximum time the patient can spend on a patient support of the scanning device.

7. The system according to claim 2, wherein the loading/unloading requirements include a measure of patient mobility based on at least one of:
an age of the patient;
a mass of the patient;
a height-mass ratio of the patient;
whether the patient is ambulatory;
whether the patient is conscious.

8. The system according to claim 1, further including:
a tracking unit which tracks each received ordered unit dose of the radiopharmaceutical, the decay of each radiopharmaceutical with time, and the intended patient; and
a forecasting unit which based on tracked unit doses of radiopharmaceuticals, and the arrival of the plurality of scheduled patients, forecasts:
the time to administer to each tracked unit dosage of radiopharmaceutical to each patient;
the time and duration to load each patient into the scanning device;
the time and duration to perform the ordered scanning procedure; and
the time and duration to unload each patient from the scanning device.

9. The system according to claim 7, wherein the forecasting unit revises the forecast based on at least one of:
a cancellation to the schedule;
an emergency addition to the schedule;
a delay in receiving of the unit doses ordered radiopharmaceutical;
a loss of at least one unit dose of radiopharmaceutical;
a delay in administering the radiopharmaceutical to at least one patient;
a delay in loading and/or unloading the patient; and
a delay due to an extended scan procedure.

10. The system according to claim 7, wherein the forecasting unit includes “what if” scenarios based on at least one proposed change to at least one patient schedule and the forecast unit forecasts the changes to all scheduled patients affected by the at least one proposed change to the at least one patient schedule as an alternative forecast.

11. A method of scheduling nuclear medicine imaging, comprising:
scheduling a plurality of patients, each for an ordered nuclear medicine scanning procedure with a nuclear medicine scanning device based on data mined from prior patients with like scanning procedures and in a time window which minimizes the patient dose.

12. The method according to claim 11, wherein the time window includes:
a time and an amount of a unit radiopharmaceutical dosage based on the ordered procedure, at least one patient characteristic and the arrival time; and
a time and a duration of a scanning procedure based on the time and dosage of the radiopharmaceutical, patient loading/unloading requirements, and the ordered procedure.

13. The method according to claim 14, wherein data mining further includes:
selecting times and durations of scanning procedures of prior patient scanning procedures based on at least one of:
radiopharmaceutical;
administered unit dose of radiopharmaceutical;
a region of interest;
a scan protocol;
scan duration;
time of day;
type of scanning device;
device options;
hours of operation; and
best practice guidelines.

14. The method according to claim 11, further including:
adjusting the schedule of at least one patient to fit into the available time window by extending the time window and reducing the administered dose.

15. The method according to claim 11, further including:
optimizing the schedule of the plurality of patients over a plurality of days based on the time needed for a quality image and a minimum dose for each patient compared with a group of prior patients, and including hours of operation and staffing breaks.

16. The method according to claim 11, further including:
tracking each received ordered unit dose of the radiopharmaceutical, the decay of each radiopharmaceutical with time, and the associated dosage for each patient; and
forecasting based on tracked unit doses of radiopharmaceuticals, and the arrival of the plurality of scheduled patients:
the time to administer to each tracked unit dosage of radiopharmaceutical to each associated patient;
the time and duration to load each patient into the scanning device;
the time and duration to perform the ordered scanning procedure; and
the time and duration to unload each patient from the scanning device.

17. The method according to claim 16, further including:
revising the forecast based on at least one of:
a cancellation to the schedule;
an emergency addition to the schedule;
a delay in receiving of the unit doses ordered radiopharmaceutical;
a loss of at least one unit dose of radiopharmaceutical;
a delay in administering the radiopharmaceutical to at least one patient;
a delay in loading and/or unloading the patient; and
a delay due to an extended scan procedure.

18. A non-transitory computer-readable storage medium carrying software which controls one or more electronic data processing devices to perform the method according to claim 11.

19. An electronic data processing device configured to perform the method according to claim 11.

20. A nuclear medicine scanner system, comprising:
at least one processor configured to:
schedule a plurality of patients for an ordered nuclear medicine scanning procedure for a nuclear medicine scanning device, each patient scheduled for:
an arrival date and time;
a time and an amount of a unit radiopharmaceutical dosage based on the ordered procedure, the patient characteristics and the arrival time; and
a time and duration of a scanning procedure based on the time and dosage of the radiopharmaceutical, patient loading/unloading requirements, and the ordered procedure; and
forecast based on received unit doses of radiopharmaceuticals, and the arrival of the plurality of scheduled patients:
the time to administer to each received unit dosage of radiopharmaceutical to each patient;
the time and duration to load each patient into the scanning device;
the time and duration to perform the ordered scanning procedure; and
the time and duration to unload each patient from the scanning device.

21. A nuclear medicine scanner system, comprising:
at least one processor configured to:
track a plurality of received ordered unit doses of radiopharmaceuticals and each tracked unit dose includes a decay of each radiopharmaceutical dose with time, and an intended patient with a scheduled arrival time and with an ordered scanning procedure; and
forecast based on data mined about use of a scanning device, the tracked unit doses of radiopharmaceuticals, and an arrival of each patient:
a time to administer each tracked unit dose to each patient,
a time and duration to load each patient into the scanning device,
a time and duration to perform the ordered scanning procedure with the scanning device, and
a time and duration to unload each patient from the scanning device.
